(19) United States
(12) Patent Application Publication
(10) Pub. No.: US 2009/0313296 A1
(43) Pub. Date: Dec. 17, 2009

(54) METHOD AND APPARATUS FOR MANAGING STORAGE

(75) Inventors: Windsor Wee Sun Hsu, San Jose, CA (US); Pin Zhou, San Jose, CA (US)

Correspondence Address: Kenneth L. Sherman, Esq.;c/o MYERS ANDRAS SHERMAN LLP, 19900 MacArthur Blvd., Suite 1150, Irvine, CA, 92612, US

(73) Assignee: International Business Machines Corporation, Armonk, NY (US)

(21) Appl. No.: 12/138,346

(22) Filed: Jun. 12, 2008

(51) Int. Cl. G06F 17/30

(52) U.S. Cl. 707/103 R; 707/E17.055

(57) ABSTRACT

The invention provides a method and apparatus for managing stored objects. The method includes providing an object management policy for stored objects, analyzing the object management policy to identify information required to execute the object management policy, acquiring the identified information from a protection repository for the stored objects, and executing the object management policy based on the acquired information to manage the stored objects.

### BACKGROUND OF THE INVENTION

1. Field of the Invention

The present invention relates generally to data storage, and in particular to managing storage data.

2. Background Information

In modern information-driven society, organizations are collecting and accumulating more data. Managing the large amount of data is both expensive and complicated. In practice, the data to be stored can have different storage requirements. For example, a data object (e.g., email, database) that is subject to certain regulations may need to be stored in immutable storage. A data object can be critical to the operation of a business and may need to be placed on fast and reliable storage, and perhaps replicated at a remote site. A file that is no longer actively being used may be suitable for archive to a low cost storage such as tape.

In general, if each data object were to be managed in accordance with its storage requirements and value to an organization, the cost and complexity of managing the data would be significantly reduced. A current approach to managing data objects according to their storage requirements relies on interviewing personnel involved with the administration of the primary data repositories to understand the kinds of data stored. In most cases, however, the administrators do not have a clear picture of the storage requirements of the data stored.

Another approach is to crawl the primary data repositories to obtain metadata (e.g., last access time, last modification time, creation time, size, owner) about the data objects, and to determine the appropriate data management actions to take based on the obtained metadata. Such an approach, however, significantly impacts the performance of the primary data repositories. Moreover, a growing volume of accumulated information is distributed among mobile computing devices such as tablet PCs, laptops, PDAs, cell phones, etc. which typically has limited network connectivity and processing capability. Furthermore, the metadata associated with a data object is typically not sufficient to determine the data management actions required.

### SUMMARY OF THE INVENTION

The invention provides a method and system for managing storage. The method includes providing an object management policy for stored objects, analyzing the object management policy to identify information required to execute the object management policy, acquiring the identified information from a protection repository for the stored objects, and executing the object management policy based on the acquired information to manage the stored objects.

Another embodiment of the invention provides an apparatus for managing stored objects. The apparatus comprising: an information acquisition module configured to retrieve a specification from one of a storage device and a user, a policy engine configured to receive an object management policy for the plurality of stored objects from one of the storage device and the user, and a policy analyzer configured to analyze the object management policy to identify information required to execute the object management policy. The information acquisition module is further configured to acquire the identified information from a protection repository for the plurality of stored objects, and the policy engine is further configured to execute the object management policy based on the acquired information to manage the plurality of stored objects.

Yet another embodiment of the invention provides a computer program product that causes a computer to provide an object management policy for a plurality of stored objects, analyze the object management policy to identify information required to execute the object management policy, acquire the identified information from a protection repository for the plurality of stored objects, and execute the object management policy based on the acquired information to manage the plurality of stored objects.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 illustrates a system for managing storage of one embodiment of the invention;

FIG. 2 illustrates a block diagram of a storage management process of an embodiment of the invention;

FIG. 3 illustrates a block diagram of a supplemental storage management process according to an embodiment of the invention; and

FIG. 4 illustrates a distributed network including a storage management system according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises etc.

The description may disclose several preferred embodiments of managing stored objects, as well as operation and/or component parts thereof. While the following description will be described in terms of backup/archive processes and devices for clarity and to place the invention in context, it should be kept in mind that the teachings herein may have broad application to all types of systems, devices and applications.

The invention provides a method and apparatus for managing stored objects. The method includes providing an object management policy for stored objects, analyzing the object management policy to identify information required to execute the object management policy, acquiring the identified information from a protection repository for the stored objects, and executing the object management policy based on the acquired information to manage the stored objects.

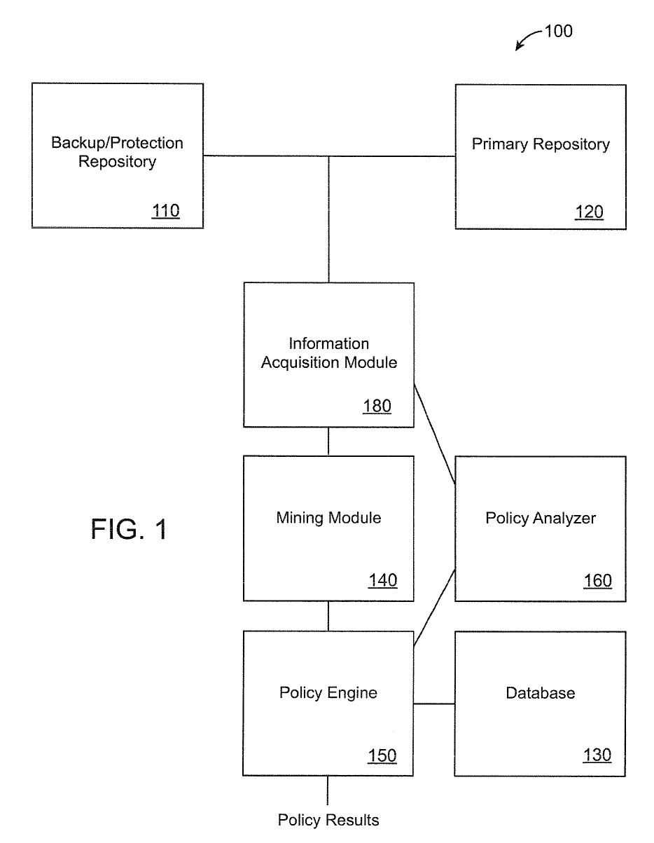

FIG. 1 illustrates a storage management system 100 of an embodiment of the invention. In one embodiment of the invention, the storage management system 100 includes a database storage 130, a mining module 140, a policy engine 150, a policy analyzer 160 and an information acquisition module 180. In one embodiment storage management system 100 is coupled to backup/protection repository 110 and primary repository 120.

The information acquisition module 180 receives the specification of the data objects to be managed from the user or receives the predefined specification from a storage device. The specification includes a list of primary data repositories to be managed, such as primary repository 120. In one embodiment of the invention, the specification includes a list of directories for each of the primary data repositories.

The policy engine 150 receives a data management policy to be executed against the data objects included in the specification. An illustrative policy is if (condition C is true) then perform (action A). The policy analyzer 160 analyzes the received data management policy to identify information necessary for executing the policy. Specifically, the policy analyzer 160 examines the condition part of the policy to determine the information needed to evaluate the condition. For example, the condition may be (last access time is earlier than Jan. 1, 2007 and the object is confidential). In this case, the policy analyzer 160 may determine that the access time attribute typically maintained by a file system is necessary. It may also determine that an extended file system attribute named “confidential” is required. In one embodiment of the invention, the policy analyzer 160 may decide that the content of the object is needed in order to perform analytics to determine whether the object is in fact confidential.

The information acquisition module 180 acquires the identified necessary information from the data backup/protection repository 110. For each object included in the specification, the information acquisition module 180 attempts to gather the identified necessary information from the data backup/protection repository 110 associated with that object. In one embodiment of the invention, the information acquisition module performs a restore of the object from the data backup/protection repository 110 and acquires the necessary information from the restored object. In another embodiment of the invention, the information acquisition module 180 selectively acquires important attributes for partial policy evaluation that can still produce the outcome of the policy condition.

In another embodiment of the invention, the information acquisition module 180 acquires the content of an object and passes it to the mining module 140 to perform analytics on the content. For example, the mining module 140 could decide whether the object is confidential, whether it relates to a positive medical test, etc. In one embodiment of the invention, the mining module 140 conforms to IBM Unstructured Information Management Architecture (UIMA). Note that by content of an object, we include additional data associated with the object, such as the closed captioning of a video clip, the header or trailer of an object such as one complying with the Digital Imaging and Communications in Medicine (DICOM) standard, etc.

In one embodiment of the invention, the information acquisition module 180 identifies any shortfall or faults in the acquired information and supplements the acquired information with supplemental information. In one embodiment of the invention, the information acquisition module 180 accesses each of the primary repositories included in the specification and retrieves a directory structure of its contents. In another embodiment of the invention, the information acquisition module 180 determines whether the information acquired from the data backup/protection repository 110 is out-of-date. For example, the information acquisition module 180 retrieves the last modified time of each object included in the specification from the corresponding primary data repositories and compares that against the last backup time of the object.

In one embodiment of the invention, the information acquisition module 180 identifies objects from the data backup/protection repository 110 that have been modified recently (with last modified time within a predetermined threshold), and checks the last modified time of these objects in the primary data repository, such as primary repository 120. The information acquisition module 180 supplements the acquired information by acquiring any identified shortfall from the primary data repository 120. The policy engine 150 executes the policy based on the acquired information. In one embodiment of the invention, the policy analyzer 160 characterizes the identified necessary information into different categories and handles different information in different ways to minimize the information retrieval cost (i.e., delay, latency, bandwidth, type of memory used, etc.). For example, information can be categorized into static (e.g., creation time of an object) and dynamic (e.g., last access time of an object), and the static information can be cached into the database 130 for subsequent use. In another embodiment of the invention, the policy engine 150 categorizes the evaluation results into different categories (e.g., static and dynamic) and handles them differently (e.g., cache the static results into the database 130 for subsequent use) for minimizing the information retrieval cost and policy evaluation cost. In another embodiment, the policy engine 150 can adjust the evaluation order of clauses in the policy condition to minimize both the information retrieval cost and policy

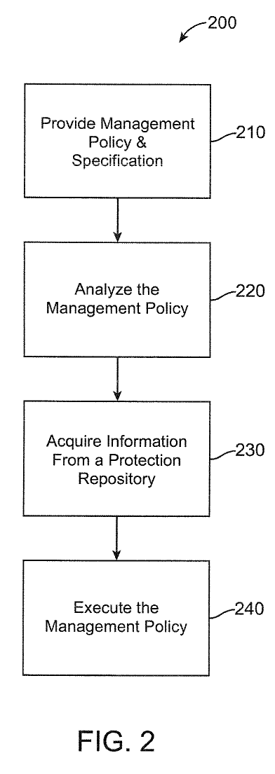

FIG. 2 illustrates a block diagram of an object management process 200 of an embodiment of the invention. Object management process 200 can be performed in a module of hardware, such as in storage management system 100, or performed from a computer program product accessible from a computer-usable or computer-readable medium providing program code for use by or in connection with a computer, processing device, or any instruction execution system. Process 200 begins with block 210 where an object management policy and a specification for stored objects is provided. In block 220, the object management policy is analyzed to identify information required to execute the object management policy. In block 230 the identified information is acquired from the backup/protection repository 110 for the stored objects. In block 240, the object management policy is executed based on the acquired information to manage the stored objects.

In one embodiment of the invention, in block 220 content of the stored objects are analyzed to identify at least one attribute of the information required to execute the object management policy. In another embodiment of the invention, at least one object is restored from a backup/protection repository (e.g., backup/protection repository 110) and the identified information is acquired for the at least one object. In another embodiment of the invention, the identified important information is selectively acquired for partial policy evaluation which can still produce the outcome of the policy condition. In yet another embodiment of the invention, a specification of the stored objects stored is retrieved from the user or a storage device. The specification includes a list of primary repositories to be managed and/or a list of directories for each of the primary data repositories. In still another embodiment of the invention, in block 220 the identified information is characterized into different categories for optimization (e.g., identified static information and dynamic information, where the static information is cached into a database 130).

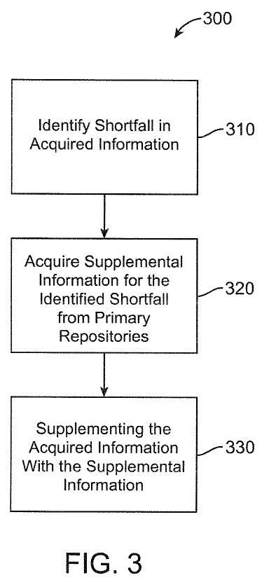

FIG. 3 illustrates a block diagram of process 300 for supplemental information acquisition according to another embodiment of the invention. Process 300 begins with block 310 for identifying a shortfall or faults in the acquired information from block 230 of process 200. In block 320 supplemental information is acquired for the identified shortfall or faults. In block 330 the acquired information in block 230 of process 200 is supplemented with the acquired supplemental information due to the shortfall or faults. In one embodiment of the invention, the identified faults include objects having a modification date that is later than the last backup date.

In one embodiment of the invention, each of the primary repositories included in the specification is assessed and a directory structure of its contents is retrieved. In another embodiment of the invention, it is determined whether the information acquired from a data backup/protection repository is out-of-date. For example, the last modified time of each object included in the specification from the corresponding primary data repositories are retrieved and compared against the last backup time of the object.

In another embodiment of the invention, process 300 identifies objects from the data backup/protection repository that have been modified recently (with last modified time within a predetermined threshold), and checks the last modified time of these objects in the primary data repository. The acquired information is supplemented by acquiring any identified shortfall from the primary data repository. The management policy is executed based on the acquired information. In one embodiment of the invention, the identified necessary information is characterized into different categories and handled differently for minimizing the information retrieval cost. For example, information can be categorized into static (e.g., creation time of an object) and dynamic (e.g., last access time of an object), and the static information can be cached into the database for subsequent use. In another embodiment of the invention, the evaluation results are categorized into different categories (e.g., static and dynamic) and handled differently (e.g., cache the static results into the database for subsequent use) for minimizing the information retrieval cost and policy evaluation cost. In another embodiment, the evaluation order of clauses in the policy condition is adjusted to minimize both the information retrieval cost and policy evaluation cost.

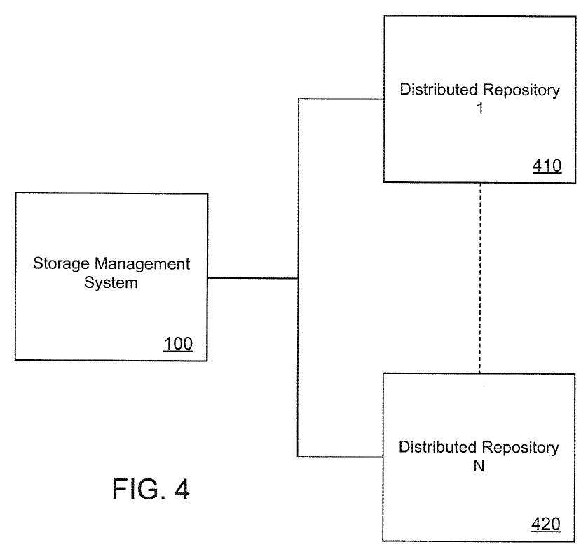

FIG. 4 illustrates an embodiment of the invention with storage management system 100 coupled to distributed repository 1 410 to distributed repository N 420, where N is a positive integer. In this embodiment of the invention, storage management system 100 manages objects stored in distributed repository 1 410 through distributed repository N 420 over a network, such as a Local Area Network (LAN), Wide Area Network (WAN), Internet, etc. The distributed repositories 1 410 through N 420 communicate over the network either wirelessly or wired directly to the network. In one embodiment, only selected distributed repositories are managed.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer, processing device, or any instruction execution system. For the purposes of this description, a computer-usable or computer readable medium can be any apparatus that can contain, store, communicate, or transport the program for use by or in connection with the instruction execution system, apparatus, or device.

The medium can be electronic, magnetic, optical, or a semiconductor system (or apparatus or device). Examples of a computer-readable medium include, but are not limited to, a semiconductor or solid state memory, magnetic tape, a removable computer diskette, a RAM, a read-only memory (ROM), a rigid magnetic disk, an optical disk, etc. Current examples of optical disks include compact disk-read only memory (CD-ROM), compact disk-read/write (CD-R/W) and DVD.

I/O devices (including but not limited to keyboards, displays, pointing devices, etc.) can be connected to the system either directly or through intervening controllers. Network adapters may also be connected to the system to enable the data processing system to become connected to other data processing systems or remote printers or storage devices through intervening private or public networks. Modems, cable modem and Ethernet cards are just a few of the currently available types of network adapters.

The current invention satisfies such a need by analyzing a data management policy to identify information necessary for executing the policy, attempting to acquire the determined necessary information from a data backup/protection repository 110, identifying any shortfall in the acquired information, supplementing the acquired information by acquiring the shortfall from a primary data repository, and executing the policy based on the acquired information.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method of managing stored objects, comprising:
providing an object management policy for a plurality of stored objects;
analyzing the object management policy to identify information required to execute the object management policy;
acquiring the identified information from a protection repository for the plurality of stored objects; and
executing the object management policy based on the acquired information to manage the plurality of stored objects.

2. The method of claim 1, further comprising:
identifying faults in the acquired information;
acquiring supplemental information for the identified faults; and
supplementing the acquired information with the supplemental information.

3. The method of claim 2, wherein the identified faults include objects having a modification date that is later than a last backup date.

4. The method of claim 1, wherein said analyzing further comprises analyzing content of the plurality of objects to identify at least one attribute of the information required to execute the object management policy.

5. The method of claim 4, further comprising restoring at least one object from the protection repository and acquiring the identified information for the at least one object.

6. The method of claim 1, wherein the object management policy is provided by one of a user and retrieved from a storage device.

7. The method of claim 1, further comprising:
retrieving a specification of the plurality of stored objects, the specification including a list of primary repositories including the plurality of objects.

8. The method of claim 7, wherein the specification is received from a user or from a storage device.

9. The method of claim 1, wherein said analyzing further comprising:
characterizing the identified information into identified information that is static and identified information that is dynamic.

10. The method of claim 9, further comprising caching the identified information that is static.

11. An apparatus for managing stored objects, comprising:
an information acquisition module configured to retrieve a specification from one of a storage device and a user,
a policy engine configured to receive an object management policy for the plurality of stored objects from one of the storage device and the user; and
a policy analyzer configured to analyze the object management policy to identify information required to execute the object management policy,
wherein the information acquisition module is further configured to acquire the identified information from a protection repository for the plurality of stored objects, and the policy engine is further configured to execute the object management policy based on the acquired information to manage the plurality of stored objects.

12. The apparatus of claim 11, further comprising:
a mining module configured to analyze content of the plurality of objects to identify at least one attribute of the information required to execute the object management policy.

13. The apparatus of claim 11, the information acquisition module further configured to:
identify faults in the acquired information;
acquire supplemental information for the identified faults; and
supplement the acquired information with the supplemental information.

14. The apparatus of claim 11, wherein the specification including a list of primary repositories including the plurality of objects.

15. A computer program product for managing stored objects comprising a computer usable medium including a computer readable program, wherein the computer readable program when executed on a computer causes the computer to:
provide an object management policy for a plurality of stored objects;
analyze the object management policy to identify information required to execute the object management policy;
acquire the identified information from a protection repository for the plurality of stored objects; and
execute the object management policy based on the acquired information to manage the plurality of stored objects.

16. The computer program product of claim 15, further cause the computer to:
identify faults in the acquired information;
acquire supplemental information for the identified faults; and
supplement the acquired information with the supplemental information.

17. The computer program product of claim 16, wherein the object management policy is provided by one of a user and retrieved from a storage device.

18. The computer program product of claim 15, wherein said analyze further comprising analyzing content of the plurality of objects to identify at least one attribute of the information required to execute the object management policy.

19. The computer program product of claim 18, further comprising restoring at least one object from the protection repository and acquiring the identified information for the at least one object.

20. The computer program product of claim 15, further causing the computer to:
retrieve a specification of the plurality of stored objects from one of a user and a storage device, the specification including a list of primary repositories including the plurality of objects.
